(19) United States
(12) Patent Application Publication
(10) Pub. No.: US 2003/0041187 A1
(43) Pub. Date: Feb. 27, 2003

(54) Method and apparatus for controlling card device

(75) Inventor: Atsushi Watanabe, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/224,273

(22) Filed: Aug. 21, 2002

(30) Foreign Application Priority Data
Aug. 24, 2001 (JP) 2001-254669

(51) Int. Cl. G06F 3/00

(52) U.S. Cl. 710/10

(57) ABSTRACT

An apparatus in which a card device is removably inserted, comprises a unit for identifying the type of a card device inserted into the apparatus, a unit for activating a card control function corresponding to the identified card device type, from a plurality of card control functions that correspond to card devices that perform different functions, and a unit for controlling the card device by using the card control function activated.

### CROSS-REFERENCE TO RELATED APPLICATIONS

This application is based upon and claims the benefit of priority from the prior Japanese Patent Application No. 2001-254669, filed Aug. 24, 2001, the entire contents of which are incorporated herein by reference.

### BACKGROUND OF THE INVENTION

1. Field of the Invention

The present invention relates to a method of and apparatus for controlling various card devices that are different in function from one another.

2. Description of the Related Art

In recent years, various types of portable electronic apparatuses, such as personal computers, PDAs (Personal Digital Assistants), cameras, mobile telephones, audio player, have been developed. In these portable electronic apparatus, various card devices are used as peripheral devices. A representative example of the card devices is a memory card. Known as memory cards are: PCMCIA cards (PC cards) and SD (Secure Digital) cards that are smaller than PCMCIA cards.

The SD card is designed to meet the demands for high security, sufficient storage capacity and high operating speed. The portable electronic apparatus which can use SD cards has a card slot into which an SD card can be removably inserted.

The SD card inserted in the card slot is controlled by a single SD device driver program, which has been installed into the portable electronic apparatus. An operating system and application programs issue access requests to the single SD device driver, when they access the SD cards.

Recently, SD cards having new function, such as SD I/O cards having communication function, have been developed. To use a SD cards having new functions in the portable electronic apparatus, it is necessary to add new card control functions to the single SD device driver. In this case, it is necessary to redevelop the SD device driver.

Therefore, even if SD cards having new function are developed, it is difficult that the SD cards having new function can be used in conventional portable electronic apparatus.

### BRIEF SUMMARY OF THE INVENTION

An object of the present invention is to provide an apparatus and a card control method that can control various SD cards that differ in function from one another.

According to an embodiment of the present invention, there is provided an apparatus in which a card device is removably inserted, comprising: means for identifying the type of a card device inserted into the apparatus; means for activating a card control function corresponding to the identified card device type, from a plurality of card control functions that correspond to card devices that perform different functions; and means for controlling the card device by using the card control function activated.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate the embodiments of the invention, and together with the general description given above and the detailed description of the embodiments given below, serve to explain the principles of the invention.

FIG. 1 is a block diagram showing the system configuration of an electronic apparatus according to an embodiment of the invention;

FIG. 2 is a diagram explaining the configuration of the device driver incorporated in the electronic apparatus;

FIG. 3 is a diagram illustrating the configuration of the ID database provided in the electronic apparatus;

FIG. 4 is a block diagram depicting the relation between the hardware and software configurations of the electronic apparatus;

FIG. 5 is a block diagram explaining the security function of the card device used in the electronic apparatus;

FIG. 6 is a flowchart explaining the sequence of steps of controlling the card control in the electronic apparatus;

FIG. 7 is a flowchart explaining how the card is controlled when the card device is removed from the electronic apparatus;

FIG. 8 is a flowchart explaining how a card device having a security function is controlled in the electronic apparatus;

FIG. 9 is a block diagram showing the clock control circuit provided in the host controller that in turn is incorporated in the electronic apparatus; and

FIG. 10 is a flowchart explaining how the clock control circuit of FIG. 9 is controlled.

### DETAILED DESCRIPTION OF THE INVENTION

An embodiment of the present invention will be described, with reference to the accompanying drawings.

(System Configuration)

FIG. 1 is a block diagram showing the system configuration of an apparatus that is an embodiment of the present invention. The apparatus 11 is a portable electronic apparatus' such as a personal computer, a PDA, a camera, a mobile telephone, or an audio player.

The housing of electronic apparatus 11 has a card slot 6, into which an SD card 10 can be removably inserted. The card slot 6 can hold various types of SD cards that perform different functions. Hence, an SD card of any type desired and selected can be inserted into the card slot 6. The electronic apparatus 11 functions as a host device for the SD card 10 inserted in the card slot 6.

The electronic apparatus 11 comprises a CPU 1, a memory 2, an input device 3, a hard disk drive (HDD) 4, and a host controller 5. These components 1, 2, 3, 4 and 5 are connected to bus 7.

The CPU 1 is a microprocessor that controls the other components of the electronic apparatus 11. The CPU 1 executes the operating system, the various application programs and various device drivers, all loaded from the hard disk drive (HDD) 4 into the memory 2. The memory 2 includes a ROM and a flash EEPROM in addition to a DRAM used as main memory. The input device 3 is a device designed to input data and commands. The input device 3 is, for a keyboard or a mouse.

The HDD 4 is an external storage device that stores the operating system, various application programs, the user data, and the like. The HDD 4 stores an SD card control program 40 and an ID database 41 as files, too.

The SD card control program 40 is software that controls the SD card 10 inserted in the electronic apparatus 11. The SD card control program 40 includes the first device driver and a plurality of second device drivers. The second device drivers are designed to meet the SD cards of various types. The second device drivers perform different card-controlling functions, respectively.

The first device driver selects the second device driver that corresponds to the type of the SD card 10 inserted in the electronic apparatus 11. The first device driver loads the selected device driver into the memory 2. Therefore, of the card-controlling functions of the second device drivers, the card-controlling function corresponding the SD card 10 inserted in the electronic apparatus 11 is activated.

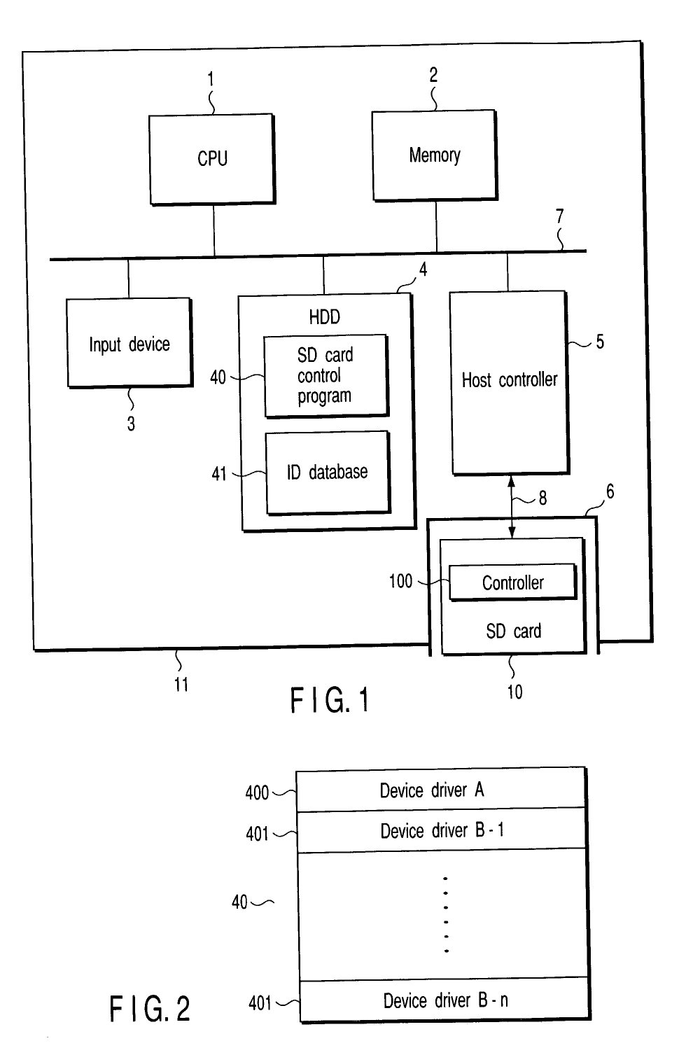

FIG. 2 illustrates the configuration of the SD card control program 40. As shown in FIG. 2, the SD card control program 40 comprises two types of device drivers, i.e., a device driver (A) 400 and device drivers B-1 to B-n. The device driver (A) 400 is the first device driver described above, whereas the device drivers B-1 to B-n 401 are the second device drivers.

The ID database 41 is a database that describes the relation between the types of SD cards and the second device drivers. The ID database 41 is used to select one of the second device drivers that corresponds to the SD card 10 inserted in the electronic apparatus 11.

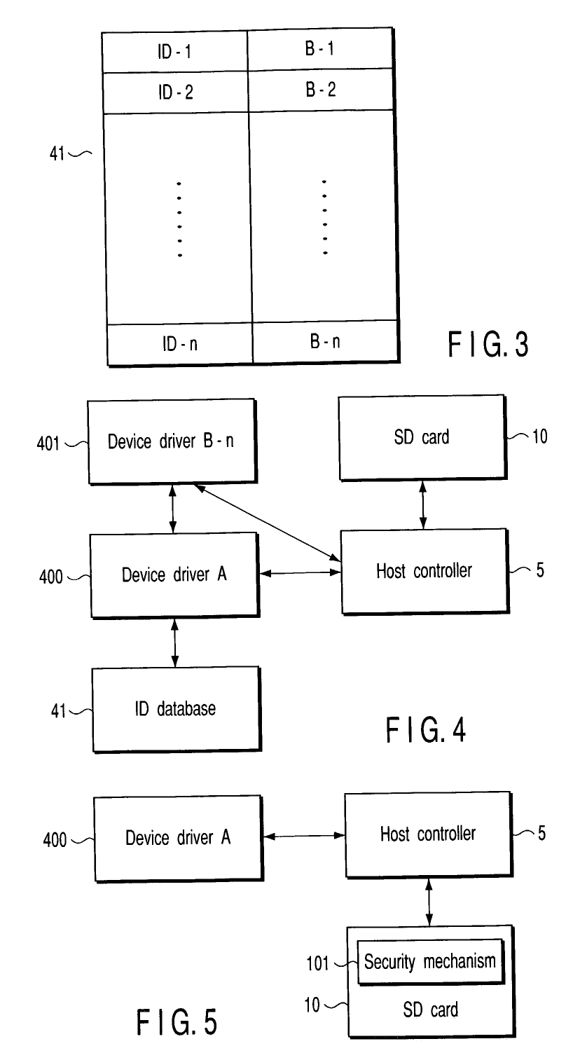

As FIG. 3 depicts, the ID database 41 comprises the ID codes (ID-1 . . . ID-n) and file names (B-1 . . . B-n). The ID codes (ID-1 . . . ID-n) are assigned to the types of SD cards. The file names (B-1 . . . B-n) pertain to the second device drivers 401 corresponding the ID codes.

The host controller 5 is a device that is designed to control the SD card 10. The host controller 5 serves as the interface between the SD cards 10 and the electronic apparatus 11 (i.e., host apparatus). The host controller 5 communicates with the SD card 10 via the connector provided in the card slot 6. All communication between the host controller 5 and the SD card 10 is controlled by a command transmitted to the SD card 10 from the host controller 5.

The connector provided in the card slot 6 has a plurality of pins. The pins constitute an SD bus 8. The SD bus 8 is used to achieve communication between the host controller 5 and the SD card 10. The SD bus 8 defines six communication lines (data DAT 0 to 3, command CMD and clock CLK) and three power-supplying lines (VDD, VSS and VSS). The six communication lines (three data lines DAT 0 to 3, command line CMD, clock line CLK) have the following functions:

DAT 0 to 3: Each data line is a bi-directional signal line used by data transfer between things of host controller 5 and SD card 10. DAT 3 is used as a card-detection signal CD showing that SD card 10 is inserted in the card slot 6, too.

CMD: This command line is used to transfer operation commands from host controller 5 to the SD card 10. (The operation commands may be referred to as “commands.”) The command line is used to transfer responses from the SD card 10 to the host controller 5, too.

CLK: The clock signal line is a signal line for transmitting a clock signal CLK from the host controller 5 to the SD card 10. Commands are transferred from the host controller 5 to the SD card 10 and data is transferred between the host controller 10 and the SD card 10, in synchronism with in the clock signal CLK.

SD card 10 is a card device employed as a peripheral device to the electronic apparatus 11. The user can insert the SD card 10 into the electronic apparatus 1, or remove the same from the electronic apparatus 1, whenever necessary.

The SD card 10 incorporates a controller 100. The controller 100 is a device that operates in accordance with a command it receives from the host controller 5. If the SD card 10 is a memory card device, the controller 100 controls the memory core (e.g., flash EEPROM) provided in the memory card device, in accordance with the command it has received. If the SD card 10 is an I/O card device, the controller 100 controls the I/O core (e.g., radio communication module of the Bluetooth™ standard) provided in the I/O card device, in accordance with the command it has received.

The controller 100 incorporates a register, too. The register holds card identification data (ID) that indicates the type of the SD card 10.

(Software Configuration)

FIG. 4 shows the relation between the device driver (A) 400 and device drivers (B) 401, on the one hand, and the hardware (i.e., host controller 5 and SD card 10), on the other.

The first device driver (A) 400 is a terminate-and-stay resident program (TSR). The first device driver (A) 400 is loaded into the main memory when the electronic apparatus 11 is powered on, no matter whether the SD card 10 is inserted in the electronic apparatus 11. Once loaded into the main memory, the first device driver (A) 400 remains in the main memory.

The first device driver (A) 400 initializes the SD card 10 by performing communication with the SD card 10 via the host controller 5. The first device driver (A) 400 selects the second device driver (B-n) 401 that should be executed. The first device driver (A) 400 has the following functions:

(1) To detect whether the SD card 10 has been inserted or removed into or from the electronic apparatus.

(2) To identify the type of the SD card 10 inserted in the electronic apparatus.

(3) To initialize SD card 10.

(4) To authenticate the SD card 10 by using the security mechanism of SD card 10.

(5) To select and activate the second device driver that corresponds to the type of the SD card 10 inserted in the electronic apparatus.

(6) To control the supply of a clock signal to the SD card 10

How the first device driver (A) 400 authenticates the SD card 10 will be explained. The SD card 10 has security mechanism 101 as shown in FIG. 5. The security mechanism 101 is used, for example, to prevent illegal copying of music data. The first device driver (A) 400 communicates with the SD card 10 through the host controller 5, performs a device authentication. The device authentication is carried out in order to determine whether the SD card 10 has a legitimate authentication mechanism.

The second device drivers (B) 401 are provided for various types of SD cards. When an SD card 10 is inserted into the electronic apparatus 11, the first device driver (A) 400 selects the second device driver (B-n) 401 that corresponds to the type of the SD card 10, loads it into the main memory and activates it.

The second device driver (B-n) 401 communicates with SD card 10 over host controller 5, in order to control the function of the SD card 10 in accordance with an access demand supplied from an application program. When the SD card 10 is removed from the electronic apparatus 11, the first device driver (A) 400 unloads the second device driver (B-n) 401 from the main memory.

(Control of the Card)

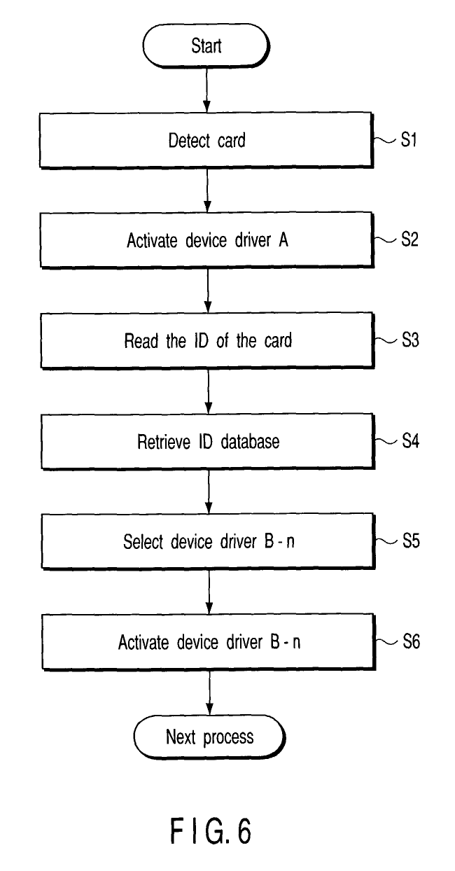

How the electronic apparatus 11 controls the SD card 10 inserted in it will be described, with reference to FIG. 6.

The data line DAT 3 of the SD bus 8 has been pull up. When the SD card 10 is inserted into the card slot 6, the electrical potential on the data line DAT 3 of the SD bus 8, i.e., the card-detection signal CD, changes from “H” level to “L” level. From this change in the electrical potential relating to the card-detection signal CD, host controller 5 detects that the SD card 10 has been inserted into the card slot 6. The host controller 5 sends the data showing this fact to the first drive driver (A) 400 (Step S1).

The host controller 5 issues an interrupt signal to the CPU 1. In response to the interrupt signal, the CPU 1 executes the first device driver (A) 400 (Step S2).

The first device driver (A) 400 reads the card identification data ID from SD card 10 inserted in the card slot 6 over host controller 5. From the card identification data ID, the first device driver (A) 400 identifies the type of the SD card 10 (Step S3). Subsequently the first device driver (A) 400 retrieves the ID database 41, using the card identification data ID as an index (Step S3). The first device driver (A) 400 selects the second device driver (B-n) 401 that corresponds to the card identification data ID (Step S4).

The first device driver (A) 400 loads the second device driver (B-n) 401, thus selected, into the main memory 2. The second device driver (B-n) 401 is thereby executed by the CPU 1 (Step S5). The second device driver (B-n) 401 controls the SD card 10 in accordance with an access demand given by the operating system or an application program.

The SD card 10 inserted in the card slot 6 may be an SD memory card. If this is the case, the second device driver (B-n) 401 that corresponds to the SD memory card is loaded in the main memory 2. Thus, the second device driver (B-n) 401 is executed. The second device driver (B-n) 401 controls the SD memory card in accordance with an access command supplied from the operating system or an application program. The second device driver (B-n) 401 causes the controller 100 provided in the SD memory card to carry out read/write control on the memory core of the card 10

If the SD card 10 inserted in the card slot 6 is an SD I/O card that performs the communication function corresponding to Bluetooth™ (Bluetooth™ SD card), the second device driver (B-n) 401 corresponding to the Bluetooth™ TM SD card is loaded into the main memory 2. The second device driver (B-n) 401 is thereby executed. The second device driver (B-n) 401 controls the Bluetooth™ SD card in accordance with a demand made by the operating system or the application program.

If the SD card 10 inserted in the card slot 6 is an SDI/O card for performing the communication function corresponding to wireless LAN (a wireless LAN SD card), the second device driver (B-n) 401 that corresponds to the wireless LAN SD card is loaded into the main memory 2 and is executed. The second device driver (B-n) 401 controls the wireless LAN SD card in accordance with a demand made by the operating system or the application program.

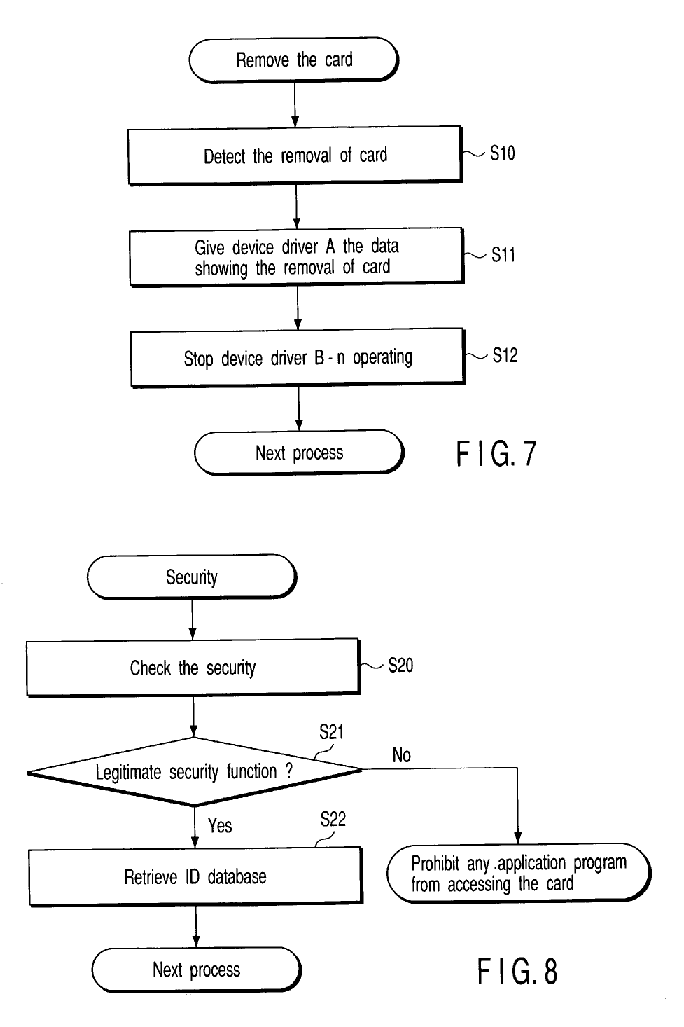

The process carried out when the SD card 10 is removed from the electronic apparatus 11 will be described, with reference to the flowchart of FIG. 7.

When the SD card 10 is removed from card slot 6, the electrical potential of the card-detection signal CD varies from “L” level to “H” level. From the change in electrical potential of the card-detection signal CD, the host controller 5 detects that the SD card 10 has been removed from the card slot 6 (Step S10). The host controller 5 supplies the data showing this fact to the first device driver (A) 400 (Step S11).

The first device driver (A) 400 releases a memory region in the main memory 2, which is assigned to the second device driver (B-n) 401. The first device driver (A) 400 unloads the second device driver (B-n) 401 from the main memory 2 (Step S12). This stops the communication between the host controller 5 and the SD card 10.

Referring to the flowchart of FIG. 8, the authentication that the first device driver (A) 400 performs will be explained. The authentication is performed during the process of identifying the card, which is carried out when it is detected that the SD card 10 is inserted in the electronic apparatus 11.

After the insertion of the SD card 10 is detected, the first device driver (A) 400 effects the process of authenticating the SD card 10, to determine whether the SD card 10 is a device that has a legitimate security function (Step S20). In this process, the authentication and key exchange are carried out between the security mechanism 101 of the SD card 10 and the first device driver (A) 400 in a specific manner prescribed. Thus, the first device driver (A) 400 determines whether the SD card 10 has a legitimate security function for protecting the contents.

If the SD card 10 is a device having a legitimate security function (YES in Step S21), the first device driver (A) 400 uses the card identification data ID acquired from the SD card 10 as an index, and retrieves the ID database 41. The first device driver (A) 400 then loads the second device driver (B-n) 401 corresponding to the ID into the main memory 2 (Step S22).

If the SD card 10 is not a device having a legitimate security function (NO in Step S21), the first device driver (A) 400 does not load the second device driver into the main memory 2. This prohibits any application program from accessing the SD card 10. The first device driver (A) 400 displays an error message on the display screen provided in the electronic apparatus 11, thereby the user may remove the SD card 10 from the apparatus 11.

The security function is utilized in order to protect the contents. Hence, of the various types of SD cards, only the SD memory card has a security function. Only if the SD card inserted in the electronic apparatus 11 is an SD memory card, it is sufficient for the first device driver (A) 400 to perform the authentication described above.

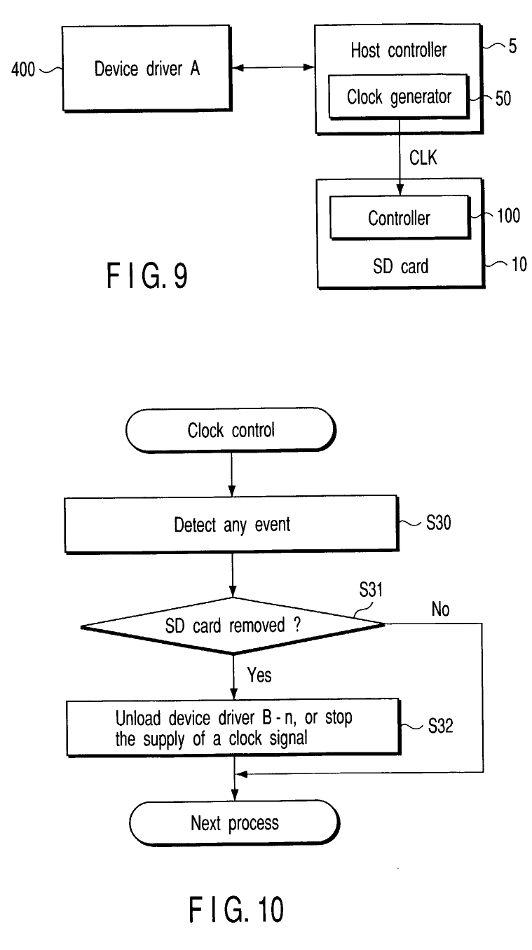

How to control the supply of a clock signal CLK to the SD card 10 will be described with reference to FIG. 9 and FIG. 10.

As FIG. 9 illustrates, the host controller 5 comprises a clock generator 50. The clock generator 50 generates a clock signal CLK that should be supplied in SD card 10. The first device driver (A) 400 has the function of permitting the clock generator 50 to generate a clock signal CLK and the function of prohibiting the device 50 from generating a clock signal CLK by clock generator 50.

When it is detected that the SD card 10 is inserted in the card slot 6, the first device driver (A) 400 causes the clock generator 50 to generate a clock signal CLK. The clock signal CLK is supplied to the SD card 10 through the SD bus 8. This enables the first device driver (A) 400 to communicate with the SD card 10 via the host controller 5. When the SD card 10 is removed from the card slot 6, or when the SD card 10 is found to be one that has no legitimate security function, the first device driver (A) 400 controls clock generator 50, stopping the supply of the clock signal CLK to the SD card 10. This helps to save the power.

The flowchart of FIG. 10 illustrates the sequence of steps of stopping the supply of the clock signal CLK when the SD card 10 is removed from the card slot 6.

As FIG. 10 shows, the first device driver (A) 400 first determines whether the SD card 10 has been removed or not, from a signal supplied from the host controller 5 (Steps S30, S31). If the first device driver (A) 400 determines that the SD card 10 has been removed from the card slot 6, it unloads the second device driver (B-n) 401 and makes the second device driver (B-n) 401 stop operating. The first device driver (A) 400 then controls the clock generator 50, causing the same to stop supplying the clock signal CLK to the SD card 10 (Step S32).

The input device 3 may generates a command when operated by the user. If the user operates the input device 3, inputting a command for stopping the use of the SD card 10, the device driver (A) 400 unloads the second device driver (B-n) 401 and makes the same stops operating. Further, the device driver (A) 400 controls the clock generator 50, causing the same to stop supplying the clock signal CLK to the SD card 10.

As described above, the first device driver (A) 401 has the function of selecting a device driver that should be executed, in accordance with the type of the SD card 10 inserted in the card slot 6. Thus, of the second device drivers 401 corresponding to the SD cards of different types, which perform different functions, the second device driver 401 that corresponds to the SD card 10 inserted in the slot 6 can be executed automatically.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus in which a card device is removably inserted, comprising:
means for identifying the type of a card device inserted into the apparatus;
means for activating a card control function corresponding to the identified card device type, from a plurality of card control functions that correspond to card devices that perform different functions; and
means for controlling the card device by using the card control function activated.

2. An apparatus according to claim 1, wherein a plurality of device drivers is installed, said device drivers corresponding to said card control functions, respectively, and said activating means includes means for activating a device driver that has a card control function corresponding to the identified card device type.

3. An electronic apparatus according to claim 1, wherein a first device driver and a plurality of second device drivers are installed, the first device driver is designed to initialize the card device inserted into the apparatus, the second device drivers are designed to perform the card control functions, and the activating means includes means for causing the first device driver to select one of the second device drivers that has a card control function which corresponds to the identified card device type.

4. An apparatus according to claim 1, further comprising:
a clock-generating device configured to supply a clock signal to the card device inserted into the apparatus; and
means for causing the clock-generating device to stop supplying the clock signal to the card device, when the card device is removed from the apparatus.

5. An apparatus in which a card device is removably inserted, a card control program controlling the card device inserted into the apparatus is installed, the card control program including a first device driver initializing the card device inserted, and a plurality of second device drivers corresponding to a plurality of card devices of different types that perform different functions, respectively, said apparatus comprising:
means for performing a process to identify the type of the card device inserted in the apparatus, by using the first device driver;
means for performing a process to activate one of the second device drivers which corresponds to the identified card device type, by using the first device driver; and
means for controlling the card device inserted in the apparatus, by using the second device driver activated.

6. An apparatus according to claim 5, wherein the process of identifying the type of card device includes a process of acquiring card identification data from the card device inserted in the apparatus.

7. An apparatus according to claim 5, wherein the process of activating the second device driver that corresponds to the identified card device type includes a process of selecting one of the second device drivers that corresponds to the identified card device type, and a process of loading the second device driver selected into a memory provided in the apparatus.

8. An apparatus according to claim 7, further comprising means for causing the first device driver to unload the second device driver selected, from the memory, when the card device is removed from the apparatus.

9. An apparatus according to claim 5, further comprising:
a clock generating device configured to supply a clock signal to the card device inserted into the apparatus; and
means for causing the clock-generating device to stop supplying the clock signal to the card device, when the card device is removed from the electronic apparatus.

10. A method of controlling a card device removably inserted in an apparatus in which a card control program controlling the card device inserted into the apparatus is installed, the card control program including a first device driver initializing the card device inserted, and a plurality of second device drivers corresponding to a plurality of card devices of different types that perform different functions, respectively, said method comprising:
causing the first device driver to identify the type of the card device inserted in the apparatus;
causing the first device driver to activate one of the second device drivers which corresponds to the identified card device type; and
causing the second device driver activated, to control the card device inserted in the apparatus.

11. A method according to claim 10, wherein the process of identifying the type of card device includes a process of acquiring card identification data from the card device inserted in the apparatus.

12. A method according to claim 10, wherein the process of activating the second device driver that corresponds to the identified card device type includes a process of selecting one of the second device drivers that corresponds to the identified card device type, and a process of loading the second device driver selected into a memory provided in the apparatus.

13. A method according to claim 12, further comprising means for causing the first device driver to unload the second device driver activated, from the memory, when the card device is removed from the apparatus.

14. A program stored in a computer-readable storage medium, the program causing a computer to control a card device inserted in the computer in accordance with a access request from a software executed by the computer, including a plurality of device drivers corresponding to a plurality of card devices of different types that perform different functions, respectively, said program comprising:
causing the computer to identify the type of the card device inserted in the computer;
causing the computer to activate one of the device drivers which corresponds to the identified card device type; and
causing the computer to execute the device driver activated, and to perform a process to control the card device inserted in the computer in accordance with a access request from the software.

15. A program according to claim 14, wherein the process of identifying the type of card device includes a process of acquiring card identification data from the card device inserted in the computer.

16. A program according to claim 14, wherein the process of activating the second device driver that corresponds to the identified card device type includes a process of selecting one of the second device drivers that corresponds to the identified card device type, and a process of loading the second device driver thus selected into a memory provided in the computer.

17. A program according to claim 16, further comprising causing the computer to unload the second device driver activated, from the memory, when the card device is removed from the computer.
